(19) United States
(12) Patent Application Publication
(10) Pub. No.: US 2019/0114162 A1
(43) Pub. Date: Apr. 18, 2019

(54) CONTROL APPARATUS, PROGRAM UPDATING METHOD, AND COMPUTER PROGRAM

(71) Applicant: Sumitomo Electric Industries, Ltd., Osaka-shi (JP)

(72) Inventor: Tatsuya Izumi, Osaka-shi (JP)

(21) Appl. No.: 16/080,739

(22) PCT Filed: Oct. 11, 2016
(86) PCT No.: PCT/JP2016/080043

§ 371 Date: Jan. 4, 2019

(30) Foreign Application Priority Data
Mar. 2, 2016 (JP) 2016-039917
Jun. 2, 2016 (JP) 2016-110613

(51) Int. Cl. G06F 8/65; G05B 13/04; H04L 29/08; H04W 4/44

(52) U.S. Cl. CPC G06F 8/65; G05B 13/048; B60W 2050/0083; H04W 4/44; H04L 67/34

(57) ABSTRACT

A control apparatus according to one aspect of the present disclosure is a control apparatus configured to control updating of a control program to be used to control a target device installed in a vehicle by an on-vehicle control device for controlling the target device. This control apparatus includes: a prediction unit configured to predict a parking/stopping time period of the vehicle to obtain a first time period as a predicted time period; and an updating control unit configured to control, based on the first time period, a process regarding updating of the control program.

### TECHNICAL FIELD

The present invention relates to a control apparatus, a program updating method, and a computer program.

This application claims priority on Japanese Patent Application No. 2016-039917 filed on Mar. 2, 2016 and Japanese Patent Application No. 2016-110613 filed on Jun. 2, 2016, the entire contents of which are incorporated herein by reference.

### BACKGROUND ART

A technique has been disclosed in which a communication control apparatus such as a gateway receives, through wireless communication, rewrite data (update program) for a control program of each of ECUs (Electronic Control Units) as on-vehicle control devices, and each ECU overwrites the control program by using the received update program, thereby remotely executing program updating for each ECU in the vehicle through wireless communication (refer to Patent Literature 1).

### CITATION LIST

### Patent Literature

PATENT LITERATURE 1: Japanese Laid-Open Patent Publication No. H5-195859

### SUMMARY OF INVENTION

A control apparatus according to one embodiment is a control apparatus configured to control updating of a control program to be used to control a target device installed in a vehicle by an on-vehicle control device for controlling the target device. The control apparatus includes: a prediction unit configured to predict a parking/stopping time period of the vehicle to obtain a first time period as a predicted time period; and an updating control unit configured to control, based on the first time period, a process regarding updating of the control program.

A program updating method according to another embodiment is a method for updating a control program to be used to control a target device installed in a vehicle by an on-vehicle control device for controlling the target device. The method includes the steps of: predicting a parking/stopping time period of the vehicle to obtain a first time period as a predicted time period; and controlling, based on the first time period, a process regarding updating of the control program.

A computer program according to still another embodiment is a computer program for causing a computer to function as a control apparatus configured to control updating of a control program to be used to control a target device installed in a vehicle by an on-vehicle control device for controlling the target device. The computer program causes the computer to function as: a prediction unit configured to predict a parking/stopping time period of the vehicle to obtain a first time period as a predicted time period; and an updating control unit configured to control, based on the first time period, a process regarding updating of the control program.

### BRIEF DESCRIPTION OF DRAWINGS

FIG. 1 is a diagram showing an overall configuration of a program updating system according to an embodiment of the present disclosure.

FIG. 2 is a block diagram showing an internal configuration of a gateway.

FIG. 3 is a block diagram showing an internal configuration of an ECU.

FIG. 4 is a block diagram showing an internal configuration of a management server.

FIG. 5 is a sequence diagram showing an example of updating of a control program of the ECU.

FIG. 6 is a block diagram showing a specific example of a functional configuration of the gateway.

FIG. 7 is a flowchart showing an example of a flow of a notification determination process in step S5 shown in FIG. 5.

FIG. 8 is a diagram showing a specific example of a traveling model of a vehicle.

FIG. 9 is a diagram showing a specific example of the traveling model of the vehicle.

### DESCRIPTION OF EMBODIMENTS

### Problems to be Solved by the Present Disclosure

Updating of a control program is performed such that a program for updating is transferred to an ECU, and the ECU overwrites the control program. Once updating of the control program is started in the ECU, the ECU cannot perform the normal operation until the updating is completed, and therefore, cannot cause the vehicle to operate. Therefore, if updating is started at the time when a user is about to drive the vehicle, a drawback such that the user cannot drive the vehicle may occur.

In order to solve such a drawback, it is conceivable that, before updating of the control program is performed, the updating is notified by means of display, and the updating is executed after an approval operation by the user is received. Thus, the updating is prevented from being started at a timing that is not intended by the user.

However, there are cases where, even when being notified before updating, the user does not desire the updating, depending on the state of the user and/or the vehicle. In such cases, even the notification may make the user feel bothered. Not only the notification but also other processes regarding updating may make the user feel bothered.

An object in one aspect of the present disclosure is to provide a control apparatus, a program updating method, and a computer program which are capable of appropriately managing timings of processes regarding updating, such as notification of program updating.

### Effect of the Disclosure

According to this disclosure, the timings of the processes regarding updating, such as notification of program updating, can be appropriately managed.

### DESCRIPTION OF EMBODIMENTS

Embodiments of the present disclosure include at least the following.

That is, a control apparatus included in the embodiments is a control apparatus configured to control updating of a control program to be used to control a target device installed in a vehicle by an on-vehicle control device for controlling the target device. The control apparatus includes: a prediction unit configured to predict a parking/stopping time period of the vehicle to obtain a first time period as a predicted time period; and an updating control unit configured to control, based on the first time period, a process regarding updating of the control program.

According to this configuration, the process regarding updating of the control program of the on-vehicle control device is performed based on the first time period that is the predicted parking/stopping time period of the vehicle. If the first time period is a time period not suitable for the process regarding updating of the control program of the on-vehicle control device, the process is not executed. Therefore, execution of the process regarding updating of the control program is appropriately managed.

Preferably, the control apparatus further includes an information acquisition unit configured to acquire information indicating the state of the vehicle, as information used for prediction of the parking/stopping time period. The prediction unit obtains the first time period by using the information for prediction and a prediction condition that is stored in advance.

Thus, the prediction accuracy of the first time period can be improved, and execution of the process regarding updating of the control program is managed more appropriately.

Preferably, the information for prediction includes at least one of a parking/stopping position and a parking/stopping time of the vehicle.

Thus, the prediction accuracy of the first time period can be improved, and execution of the process regarding updating of the control program is managed more appropriately.

Preferably, the information acquisition unit acquires, as the information for prediction, the information indicating the state of the vehicle, at the timing when a pre-stop state, which is prescribed as a state of the vehicle immediately before parking/stopping, is detected.

Thus, the first time period is predicated at the timing when the vehicle is highly likely to be parked/stopped, and the process regarding updating of the control program is controlled based on the first time period. Therefore, execution of the process regarding updating of the control program is appropriately managed.

Preferably, the prediction unit obtains the first time period by using, as the prediction condition, a traveling model obtained based on an accumulated traveling state of the vehicle.

Thus, the prediction accuracy of the first time period can be improved, and execution of the process regarding updating of the control program is managed more appropriately.

Preferably, the control apparatus further includes a model generation unit configured to generate the traveling model, based on the accumulated traveling state of the vehicle.

Thus, the prediction accuracy of the first time period can be improved, and execution of the process regarding updating of the control program is managed more appropriately.

Preferably, the updating control unit controls the process regarding updating of the control program, based on a result of comparison between the first time period and a second time period that is a time period required for the process regarding updating of the control program.

Thus, execution of the process regarding updating of the control program is managed more appropriately.

Preferably, the control apparatus further includes: an update time period acquisition unit configured to acquire the second time period; and a determination unit configured to determine whether or not execution of the process regarding updating of the control program is possible, by comparing the first time period with the second time period.

Thus, whether or not execution of the process regarding updating of the control program is possible can be determined with high accuracy, and execution of the process regarding updating of the control program is managed more appropriately.

Preferably, the determination unit determines whether or not execution of the process regarding updating of the control program is possible, also based on a state of a device installed in the vehicle.

Thus, whether or not execution of the process regarding updating of the control program is possible can be determined with higher accuracy, and execution of the process regarding updating of the control program is managed more appropriately.

Preferably, the updating control unit performs notification of updating of the control program, as the process regarding updating of the control program.

Thus, notification of updating of the control program is appropriately managed.

An updating method included in the embodiments is a method for updating a control program to be used to control a target device installed in a vehicle by an on-vehicle control device for controlling the target device. The method includes the steps of: predicting a parking/stopping time period of the vehicle to obtain a first time period as a predicted time period; and controlling, based on the first time period, a process regarding updating of the control program.

According to this configuration, the process regarding updating of the control program of the on-vehicle control device is performed based on the first time period that is the predicted parking/stopping time period of the vehicle. If the first time period is a time period not suitable for the process regarding updating of the control program of the on-vehicle control device, the process is not executed. Therefore, execution of the process regarding updating of the control program is appropriately managed.

A program included in the embodiments is a computer program for causing a computer to function as a control apparatus configured to control updating of a control program to be used to control a target device installed in a vehicle by an on-vehicle control device for controlling the target device. The computer program causes the computer to function as: a prediction unit configured to predict a parking/stopping time period of the vehicle to obtain a first time period as a predicted time period; and an updating control unit configured to control, based on the first time period, a process regarding updating of the control program.

According to this configuration, the process regarding updating of the control program of the on-vehicle control device is performed based on the first time period that is the predicted parking/stopping time period of the vehicle. If the first time period is a time not suitable for the process regarding updating of the control program of the on-vehicle control device, the process is not executed. Therefore, execution of the process regarding updating of the control program is appropriately managed.

### DETAILED DESCRIPTION OF EMBODIMENT

Hereinafter, preferred embodiments will be described with reference to the drawings. In the following description, the same reference numerals refer to the same components and constituent elements. The names and functions thereof are also the same. Therefore, repeated description thereof is not necessary.

### First Embodiment

### Overall Configuration of System

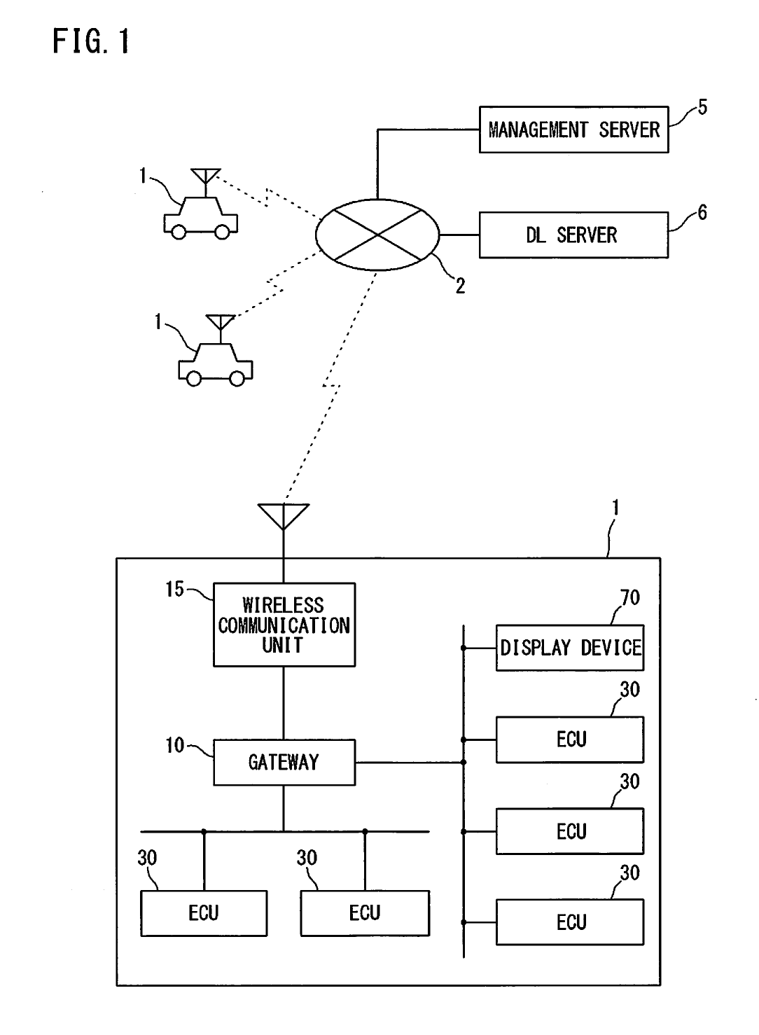

FIG. 1 is a diagram showing an overall configuration of a program updating system according to an embodiment of the present disclosure.

As shown in FIG. 1, the program updating system of this embodiment includes vehicles 1, a management server 5, and a DL (download) server 6 which are able to communicate with each other via a wide-area communication network 2.

The management server 5 and the DL server 6 are operated by, for example, the automobile manufacturer of the vehicles 1, and are able to communicate with large numbers of vehicles 1 owned by users registered as members in advance.

Each vehicle 1 is equipped with a gateway 10, a wireless communication unit 15, a plurality of ECUs 30, various on-vehicle devices (not shown) controlled by the respective ECUs 30, and a display device 70.

A plurality of communication groups, each being formed by a plurality of ECUs 30 bus-connected to a common in-vehicle communication line, are present in the vehicle 1, and the gateway 10 relays communication between the communication groups. Therefore, a plurality of in-vehicle communication lines are connected to the gateway 10.

The display device 70 is a device capable of displaying information in accordance with a control signal from the gateway 10. For example, the display device 70 may be a display-dedicated device having a display function only, or may be a display device installed in an on-vehicle device, such as a car navigation device or an on-vehicle television receiver, that is capable of communicating with the gateway 10. Alternatively, the display device 70 may be a display device installed in a mobile terminal device such as a cellular phone or a tablet-type terminal that is carried by the user and is able to communicate with the gateway 10.

The wireless communication unit 15 is communicably connected to the wide-area communication network 2 such as a mobile phone network, and is connected to the gateway 10 via an in-vehicle communication line. The gateway 10 transmits, to the ECUs 30, information received by the wireless communication unit 15 from external devices, such as the management server 5 and the DL server 6, through the wide-area communication network 2.

The gateway 10 transmits information obtained from the ECUs 30 to the wireless communication unit 15, and the wireless communication unit 15 transmits the information to the external devices such as the management server 5.

As for the wireless communication unit 15 installed in the vehicle 1, a device possessed by the user, such as a mobile phone, a smart phone, a tablet-type terminal, or a notebook PC (Personal Computer) is conceivable.

FIG. 1 shows an exemplary case where the gateway 10 communicates with the external devices via the wireless communication unit 15. However, if the gateway 10 has a wireless communication function, the gateway 10 itself may wirelessly communicate with the external devices such as the management server 5.

In the program updating system shown in FIG. 1, the management server 5 and the DL server 6 are configured as separated servers. However, these serves 5 and 6 may be configured as a single server unit.

### Internal Configuration of Gateway

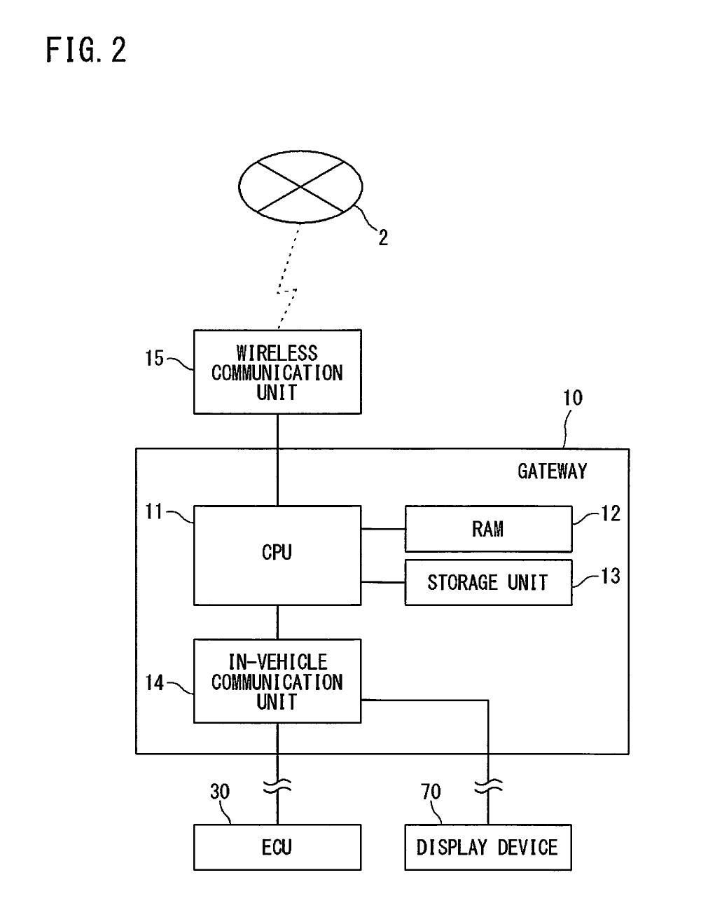

FIG. 2 is a block diagram showing the internal configuration of the gateway 10. As shown in FIG. 2, the gateway 10 includes a CPU (Central Processing Unit) 11, an RAM (Random Access Memory) 12, a storage unit 13, an in-vehicle communication unit 14, and the like. Although the gateway 10 is connected to the wireless communication unit 15 via the in-vehicle communication line, the gateway 10 and the wireless communication unit 15 may be configured as a single unit.

The CPU 11 causes the gateway 10 to function as a relay device for relaying various kinds of information, by reading out one or a plurality of programs stored in the storage unit 13 to the RAM 12 and executing the read programs.

The CPU 11 can execute a plurality of programs in parallel by switching between the plurality of programs in a time sharing manner, for example. The CPU 11 may be a CPU representing a plurality of CPU groups. In this case, a function to be implemented by the CPU 11 is a function to be implemented by the plurality of CPU groups in cooperation with each other. The RAM 12 consists of a memory element such as an SRAM (Static RAM) or a DRAM (Dynamic RAM), and temporarily stores therein programs to be executed by the CPU 11, data required in executing the programs, and the like.

A computer program implemented by the CPU 11 can be transferred in a state of being recorded in a well-known recording medium such as a CD-ROM or a DVD-ROM, or may be transferred by data transmission (download) from a computer device such as a server computer.

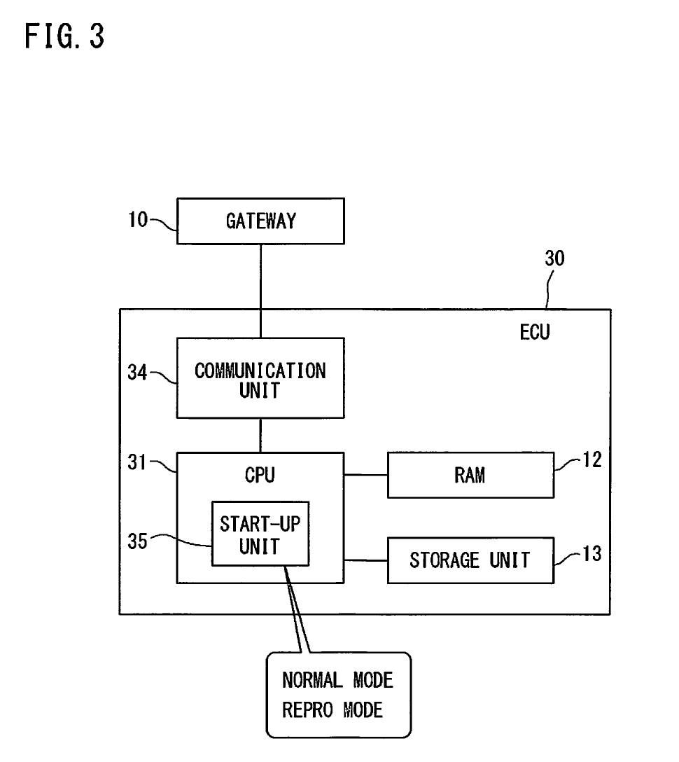

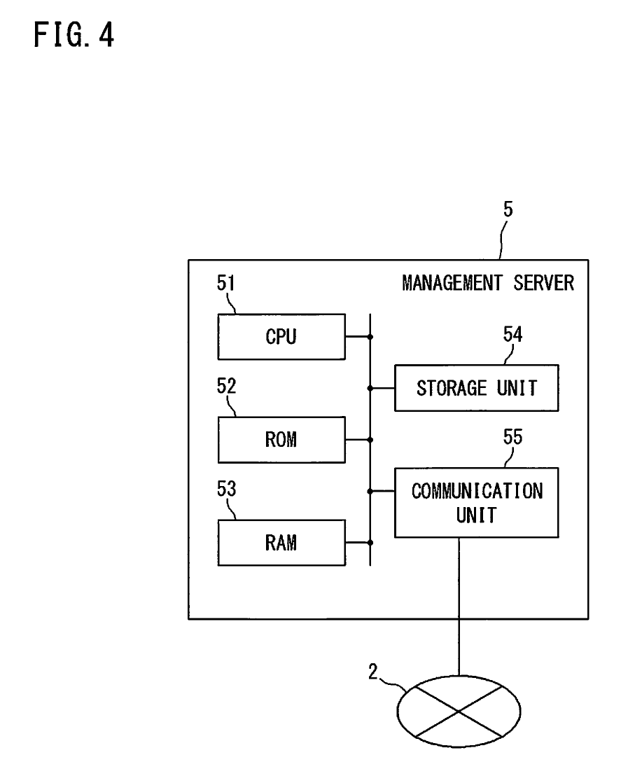

In this aspect, the same applies to a computer program to be executed by a CPU 31 of the ECU 30 (refer to FIG. 3) described later, and a computer program to be executed by a CPU 51 of the management server 5 (refer to FIG. 4) described later.

The storage unit 13 consists of, for example, a nonvolatile memory element such as a flash memory or an EEPROM (Electrically Erasable Programmable Read Only Memory).

The storage unit 13 has a storage area in which programs to be executed by the CPU 11, data required in executing the programs, and the like are stored. In the storage unit 13, update programs of the respective ECUs 30, received from the DL server 6, and the like are also stored.

The plurality of ECUs 30 and the display device 70 are connected to the in-vehicle communication unit 14 via the in-vehicle communication lines arranged in the vehicle 1. The in-vehicle communication unit 14 communicates with the ECUs 30 and the display device 70 in accordance with a standard such as CAN (Controller Area Network), CANFD (CAN with Flexible Data Rate), LIN (Local Interconnect Network), Ethernet (registered trademark), or MOST (Media Oriented Systems Transport: MOST is a registered trademark), for example.

The in-vehicle communication unit 14 transmits information provided from the CPU 11 to target ECUs 30 and the display device 70, and provides information received from the ECUs 30 to the CPU 11. If the display device 70 has a function of receiving an input operation performed by the user, the in-vehicle communication unit 14 provides information received from the display device 70 to the CPU 11. The in-vehicle communication unit 14 may communicate with the ECUs 30 and the display device 70 in accordance with other communication standards that are used for an on-vehicle network, apart from the above communication standards.

The wireless communication unit 15 consists of a wireless communication apparatus including an antenna and a communication circuit that executes transmission/reception of radio signals through the antenna. The wireless communication unit 15 is able to communicate with the external devices when being connected to the wide-area communication network 2 such as a mobile phone network.

The wireless communication unit 15 transmits information provided from the CPU 11 to the external devices such as the management server 5 via the wide-area communication network 2 formed by a base station (not shown), and provides information received from the external devices to the CPU 11.

Instead of the wireless communication unit 15 shown in FIG. 2, a wired communication unit that serves as a relay device inside the vehicle 1 may be adopted. The wired communication unit has a connector to which a communication cable conforming to a standard such as USB (Universal Serial Bus) or RS232C is connected, and performs wired communication with another communication device connected thereto via the communication cable.

If the other communication device and the external device such as the management server 5 can wirelessly communicate with each other via the wide-area communication network 2, the external device and the gateway 10 are able to communicate with each other through a communication path consisting of, in order, the external device, the other communication device, the wired communication unit, and the gateway 10.

### Internal Configuration of ECU

FIG. 3 is a block diagram showing the internal configuration of an ECU 30.

As shown in FIG. 3, the ECU 30 includes a CPU 31, an RAM 32, a storage unit 33, a communication unit 34, and the like. The ECU 30 is an on-vehicle control device that individually controls a target device installed in the vehicle 1. Examples of the types of the ECU 30 include an engine control ECU, a steering control ECU, and a door lock control ECU.

The CPU 31 controls the operation of a target device that the CPU 31 is in charge of, by reading out one or a plurality of programs previously stored in the storage unit 33 to the RAM 32 and executing the read programs. The CPU 31 may also be a CPU representing a plurality of CPU groups, and a control to be performed by the CPU 31 may be a control to be performed by the plurality of CPU groups in cooperation with each other.

The RAM 32 consists of a memory element such as an SRAM or a DRAM, and temporarily stores therein programs to be executed by the CPU 31, data required in executing the programs, and the like.

The storage unit 33 consists of, for example, a nonvolatile memory element such as a flash memory or an EEPROM, or a magnetic storage device such as a hard disk.

Information stored in the storage unit 33 includes, for example, a computer program (hereinafter referred to as “control program”) that causes the CPU 31 to execute information processing for controlling a target device to be controlled, inside the vehicle.

The gateway 10 is connected to the communication unit 34 via the in-vehicle communication lines arranged in the vehicle 1. The communication unit 34 communicates with the gateway 10 in accordance with a standard such as CAN, Ethernet, or MOST, for example.

The communication unit 34 transmits information provided from the CPU 31 to the gateway 10, and provides information received from the gateway 10 to the CPU 31. The communication unit 34 may communicate with the gateway 10 in accordance with other communication standards that are used for the on-vehicle network, apart from the above communication standards.

The CPU 31 of the ECU 30 includes a start-up unit 35 that switches the mode of control performed by the CPU 31, between a “normal mode” and a “reprogramming mode” (hereinafter also referred to as “repro mode”).

The normal mode is a control mode in which the CPU 31 of the ECU 30 executes original control for the target device (e.g., engine control for a fuel engine, or door lock control for a door lock motor).

The reprogramming mode is a control mode in which the CPU 31 updates the control program used for controlling the target device.

That is, the reprogramming mode is a control mode in which the CPU 31 performs erasing/overwriting of the control program from/on an ROM area in the storage unit 33. Only when the CPU 31 is in this control mode, the CPU 31 is allowed to update the control program stored in the ROM area in the storage unit 33 to a new version of the control program.

When the CPU 31, in the repro mode, writes the new version of the control program into the storage unit 33, the start-up unit 35 temporarily restarts (resets) the ECU 30, and executes a verifying process on a storage area where the new version of the control program has been written.

After completion of the verifying process, the start-up unit 35 operates the CPU 31 with the updated control program.

### Internal Structure of Management Server

FIG. 4 is a block diagram showing the internal structure of the management server 5.

As shown in FIG. 4, the management server 5 includes a CPU 51, an ROM 52, an RAM 53, a storage unit 54, a communication unit 55, and the like.

By reading out one or a plurality of programs previously stored in the ROM 52 to the RAM 53 and executing the read programs, the CPU 51 controls the operation of each hardware component, and causes the management server 5 to function as an external device that is able to communicate with the gateway 10. The CPU 51 may also be a CPU representing a plurality of CPU groups, and a function to be implemented by the CPU 51 may be a function to be implemented by the plurality of CPU groups in cooperation with each other.

The RAM 53 consists of a memory element such as an SRAM or a DRAM, and temporarily stores therein programs to be executed by the CPU 51, data required in executing the programs, and the like.

The storage unit 54 consists of, for example, a nonvolatile memory element such as a flash memory or an EEPROM, or a magnetic storage device such as a hard disk.

The communication unit 55 consists of a communication device that executes a communication process in accordance with a predetermined communication standard. The communication unit 55 executes the communication process when being connected to the wide-area communication network 2 such as a mobile phone network. The communication unit 55 transmits information provided from the CPU 51 to external devices via the wide-area communication network 2, and provides information received via the wide-area communication network 2 to the CPU 51.

### Control Program Updating Sequence

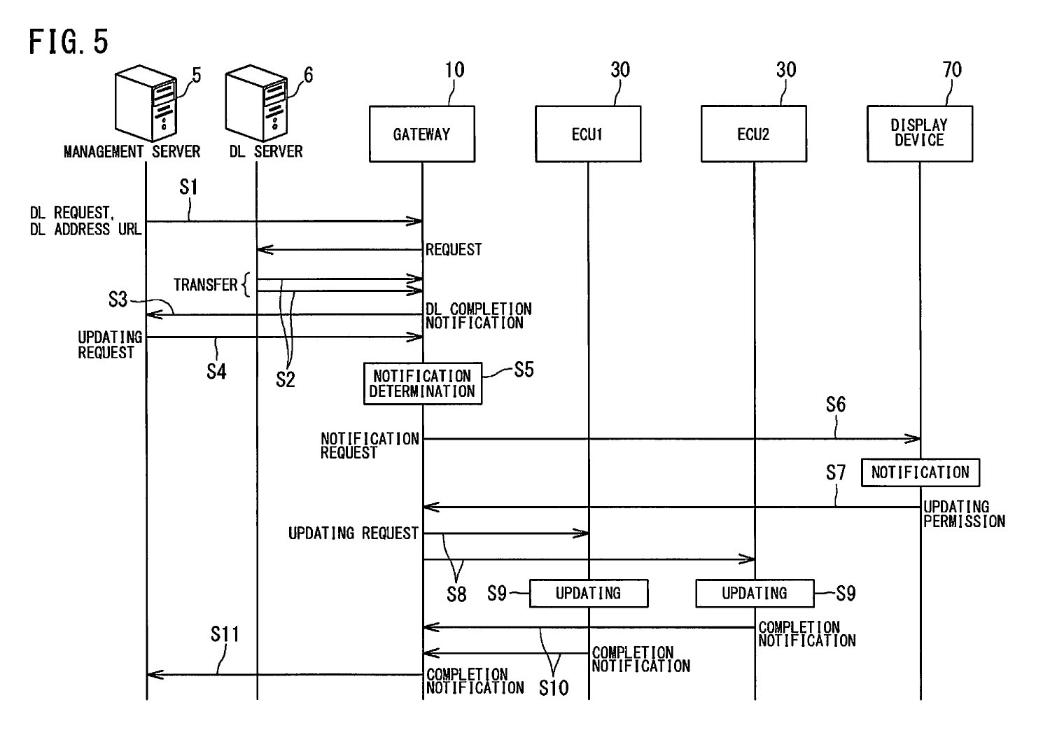

FIG. 5 is a sequence diagram showing an example of updating of a control program for an ECU, which is executed in the program updating system of the present embodiment. For example, as for a vehicle 1 that is owned by a user registered as a member in advance, the management server 5 determines the timing to update a control program of an ECU of the vehicle 1. The timing of updating may be set by, for example, the automobile manufacturer of the vehicle 1.

When the timing to update the control program of the ECU has come, the management server 5 transmits a download request and a URL where an update program for the ECU 30 is stored, to the gateway 10 of the corresponding vehicle 1 (step S1).

Thereby, the gateway 10 downloads the update program for the ECU 30 from the DL server 6 (step S2). The gateway 10 temporarily stores and preserves the received update program in the storage unit 13 thereof.

Upon completion of the storage of the update program, the gateway 10 notifies the management server 5 that DL has been normally completed (step S3). If updating is automatically continued, the management server 5, which has received the DL completion notification, transmits a control program updating request to the gateway 10. After completion of the DL, the management server 5 may temporarily suspend the process, and may transmit the control program updating request to the gateway 10 upon receiving an updating request from the outside (step S4).

Upon receiving the updating request, in order to update the control program by using the update program stored in the storage unit 13, the gateway 10 determines (notification determination) whether or not it is time to perform a process of notifying updating of the control program in the corresponding ECU 30, which is an example of a process regarding updating of the control program (step S5). Then, based on the result of the notification determination, the gateway 10 controls the process of notifying updating of the control program in the corresponding ECU 30, which is an example of the process regarding updating of the control program. That is, upon determining that it is time to perform the process of notifying updating, the gateway 10 transfers information for display to the display device 70, and requests the display device 70 to make a display that notifies updating of the control program in the corresponding ECU 30 (step S6).

The display on the display device 70 may be, for example, “Will you update XX function?” or “XX function is updatable. Update now? Later?”, or may be a notification asking about the timing of updating. In this case, an approval operation or a selection operation performed by the user is received through the display device 70 or an input device (not shown), and permission for updating is given from the device to the gateway 10 (step S7).

After being notified of updating through the display on the display device 70 or when being given permission for updating based on the user operation, the gateway 10 transmits a control program updating request to the corresponding ECU 30 (step S8).

Upon receiving the control program updating request, the corresponding ECU 30 switches the control mode thereof from the normal mode to the repro mode. Thereby, the ECU becomes able to perform a control program updating process.

The ECU 30 expands the received update program and applies the update program to the old version of the control program, thereby overwriting the old version of the control program with the new version of the control program (step S9). Upon completion of the updating of the control program, the ECU 30 transmits an updating completion notification to the gateway 10 (step S10). Upon receiving the updating completion notification from the corresponding ECU 30, the gateway 10 transmits an updating completion notification to the management server 5 (step S11).

### Functional Configuration of Gateway

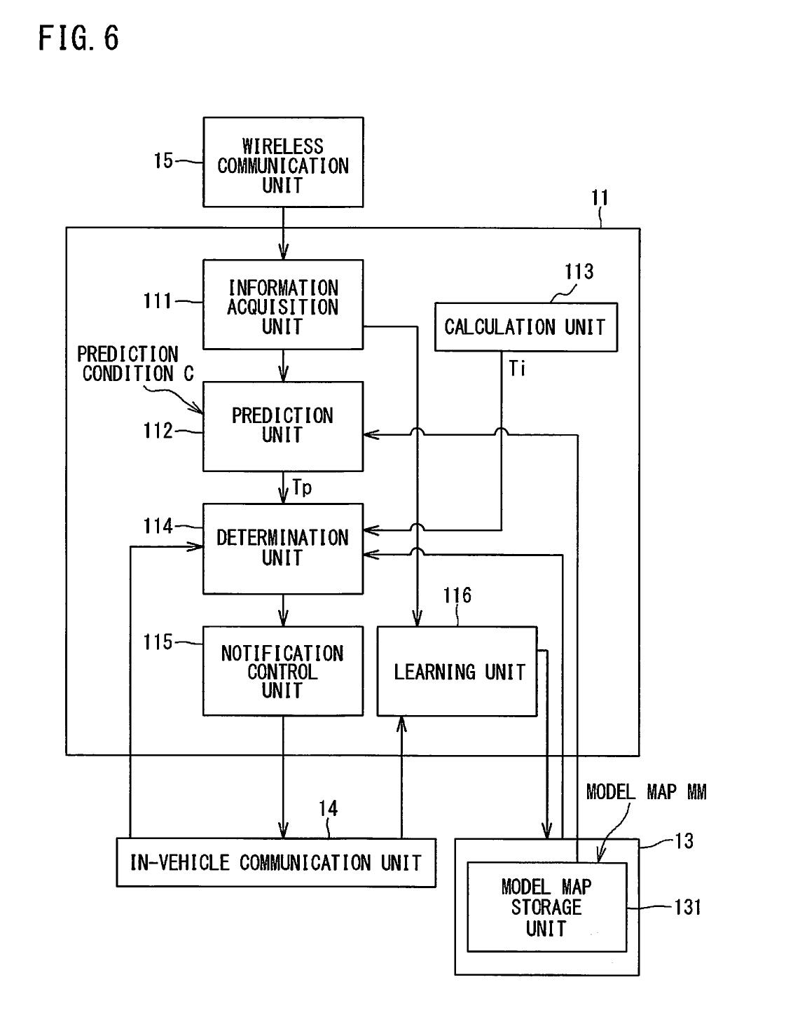

FIG. 6 is a block diagram showing a specific example of a functional configuration of the gateway 10, for performing the notification determination indicated in step S5 described above. Functions shown in FIG. 6 are implemented mainly by the CPU 11 of the gateway 10 such that the CPU 11 reads out the programs stored in the storage unit 13 to the RAM 12 and executes the read programs.

Specifically, with reference to FIG. 6, the CPU 11 of the gateway 10 includes: an information acquisition unit 111 that acquires prediction information that is information required for prediction of a parking/stopping time period Tp (first time period) of a vehicle 1; a prediction unit 112 that predicts the parking/stopping time period Tp by using the prediction information; a calculation unit 113 that calculates an update time period Ti (second time period) that is a time period required for updating of the control program; a determination unit 114 that determines whether or not notification is possible, by using the parking/stopping time period Tp and the update time period Ti; and a notification control unit 115 that controls notification, based on the determination result.

The prediction information includes at least one of information indicating a parking/stopping position of the vehicle 1 and information indicating a parking/stopping time of the vehicle 1. The information indicating the parking/stopping position includes, for example, information (latitude and longitude, address, or the like) indicating the parking/stopping position itself, information indicating a parking/stopping range, and the like. For example, the information acquisition unit 111 is able to acquire, as the prediction information, the present position of the vehicle 1 or a range to which the present position belongs, by communicating with a GPS (Global Positioning System) or a user's mobile terminal device such as a smart phone, which are not shown, through the wireless communication unit 15. The information acquisition unit 111 may acquire, as the prediction information, the present position of the vehicle 1 or the range to which the present position belongs, based on, for example, a previously registered traveling start position, such as the location of the user's home, and traveling information that is acquired from a traveling-system ECU 30 by communicating with the ECU 30 through the in-vehicle communication unit 14.

The information indicating the parking/stopping time includes, for example, date and time when parking is started, time of day at which parking is started, and a time period including the time of day at which parking is started. For example, the information acquisition unit 111 is able to acquire, as the prediction information, information indicating the parking/stopping time, based on a standard radio wave received by the wireless communication unit 15, or by reading out the information from the user's mobile terminal device such as a smart phone. The information acquisition unit 111 may include a calendar function or a clock function (not shown), and may acquire, as the prediction information, information indicating the parking/stopping time by using the function.

Preferably, the prediction information further includes information regarding the states of on-vehicle devices, such as: whether or not a destination is set in a navigation device; whether or not an engine is in the idling state; whether or not the vehicle is being charged if the vehicle is an electric automobile; and a charging completion time required until the fully charged condition. The information acquisition unit 111 is able to acquire, as the prediction information, information such as the engine state, by communicating with the corresponding ECU 30 through the in-vehicle communication unit 14, for example. Alternatively, the information acquisition unit 111 may acquire, as the prediction information, information indicating whether or not a destination is set, by communicating with the navigation device or the user's mobile terminal device, such as a smart phone, having a navigation function, through the wireless communication unit 15.

The prediction unit 112 stores therein a prediction condition C in advance. The prediction unit 112 applies the prediction condition C to the acquired prediction information, thereby predicting the parking/stopping time period Tp.

The prediction condition C is a condition that defines a correspondence between the parking/stopping time period Tp of the vehicle 1, and at least one of the information regarding the parking/stopping position and the information regarding the parking/stopping time, preferably, at least a combination of the information regarding the parking/stopping position and the information regarding the parking/stopping time. Specifically, the prediction condition C is an association of the parking/stopping position with the parking/stopping time period Tp, an association of the parking/stopping position and the parking/stopping time with the parking/stopping time period Tp, an association of the parking/stopping time with the parking/stopping time period Tp, or the like. In the case where the same user or the same user group uses the vehicle 1, it is conceivable that how the vehicle 1 is used, that is, when and where the vehicle 1 is parked/stopped, has a certain tendency (pattern). Therefore, by setting predicted values of the parking/stopping time period based on the tendency in advance, the parking/stopping time period can be easily predicated with high accuracy.

More preferably, the prediction condition C further defines a correspondence between the parking/stopping time period Tp of the vehicle 1, and a combination of any of the above conditions and the state of any of the on-vehicle devices. Specifically, the prediction condition C is an association of the parking/stopping position and the state of the on-vehicle device with the parking/stopping time period Tp, an association of the parking/stopping time and the state of the on-vehicle device with the parking/stopping time period Tp, or the like. For example, it is assumed that the parking/stopping time period Tp is not long if a destination is set in the navigation device and the parking/stopping position is at a place different from the destination, and that the parking/stopping time period Tp is longer than the charging completion time if the parking/stopping time is within a time period at night and the vehicle 1 is being charged. Therefore, by setting prediction values of the parking/stopping time period based on these assumptions in advance, the parking/stopping time period can be easily predicated with high accuracy.

The prediction condition C may be information such as a table in which the above correspondences are defined. Examples of the prediction condition C include the following conditions 1 to 5. The prediction condition C may be an arithmetic formula with which the parking/stopping time period Tp of the vehicle 1 can be calculated based on the following conditions 1 to 5.

Condition 1) parking/stopping position: point A (e.g., user's home)→parking/stopping time period Tp=8 (hours)

Condition 2) parking/stopping position: point A+parking/stopping time: time period B (e.g., nighttime)→parking/stopping time period Tp=3 (hours)

Condition 3) parking/stopping position: other than point A→parking/stopping time period Tp=1 (hour)

Condition 4) navigation device: destination being set+parking/stopping position: other than the destination→parking/stopping time period Tp=10 (minutes)

Condition 5) parking/stopping time: time period B+during charging→parking/stopping time period Tp=charging completion time

In the program updating system according to the first embodiment, the prediction condition C is registered in the gateway 10 by a registration operation performed by the user, for example. The registration may be performed at the time of membership registration to the management server 5, and the information of the registered prediction condition C may be transferred from the management server 5 to the corresponding gateway 10. Alternatively, the registration may be performed such that the information of the prediction condition C is transferred from the user's mobile terminal device such as a smart phone to the gateway 10, in accordance with user operation performed to the mobile terminal device. Thus, the user is allowed to customize the timing of notification of updating of the control program. The prediction condition C may be registered in the gateway 10 in advance. Thus, complicated user operation can be dispensed with.

The calculation unit 113 is an example of an update time period acquisition unit that acquires the update time period Ti. The calculation unit 113 calculates the update time period Ti, based on the update program acquired from the DL server 6, and on a communication group configuration (network topology) of a plurality of ECUs 30, which is stored in advance, the updating abilities of the ECUs 30, or the like. As another example, the update time period acquisition unit may acquire the update time period Ti from the management server 5 or the DL server 6.

The determination unit 114 is an example of a determination result acquisition unit that acquires the determination result as to whether or not notification is possible. The determination unit 114 determines whether or not notification is possible, by comparing the parking/stopping time period Tp with the update time period Ti. For example, the determination unit 114 determines that notification is possible, when the update time period Ti is shorter than the parking/stopping time period Tp (Ti<Tp). This is based on an idea that updating of the control program is expected to be completed within the parking/stopping time period Tp, and the user is less likely to feel inconvenience even if he/she cannot drive the vehicle 1 during the updating.

As another example, the determination unit 114 determines that notification is possible, when the update time period Ti is shorter than a time corresponding to a predetermined percentage (α) of the parking/stopping time period Tp (Ti<(Tp×α)). This is based on an idea that updating of the control program is expected to be completed within the parking/stopping time period Tp, and the user is less likely to feel inconvenience even if he/she cannot drive the vehicle 1 during the updating.

The information regarding the state of the on-vehicle device, of the prediction condition C used by the prediction unit 112, may be used as a determination condition by the determination unit 114. For example, even when the update time period Ti is shorter than the parking/stopping time period Tp (Ti<Tp) predicted according to any of the above conditions 1) to 3), if a destination is set in the navigation device, the determination unit 114 does not determine that notification is possible. Thus, whether or not notification is possible can be determined with higher accuracy.

As another example, the determination result acquisition unit may acquire the determination result from the management server 5 or the ECU 30, in the case where the management server 5 or the ECU 30 determines whether or not notification is possible as described above.

The notification control unit 115 is an example of an updating control unit that controls the processes regarding updating of the control program. When the determination unit 114 has determined that notification is possible, the notification control unit 115 performs a control for requesting the display device 70 to perform notification of updating of the control program. Otherwise, the notification control unit 115 does not perform the request. As another example, the updating control unit may control the control program updating process itself, in accordance with the determination result from the determination unit 114. The notification control unit 115 as an example of the updating control unit may control the notification, based on the determination result as to whether or not notification is possible, and on whether or not the user has performed an operation to approve updating of the control program.

### Notification Determination

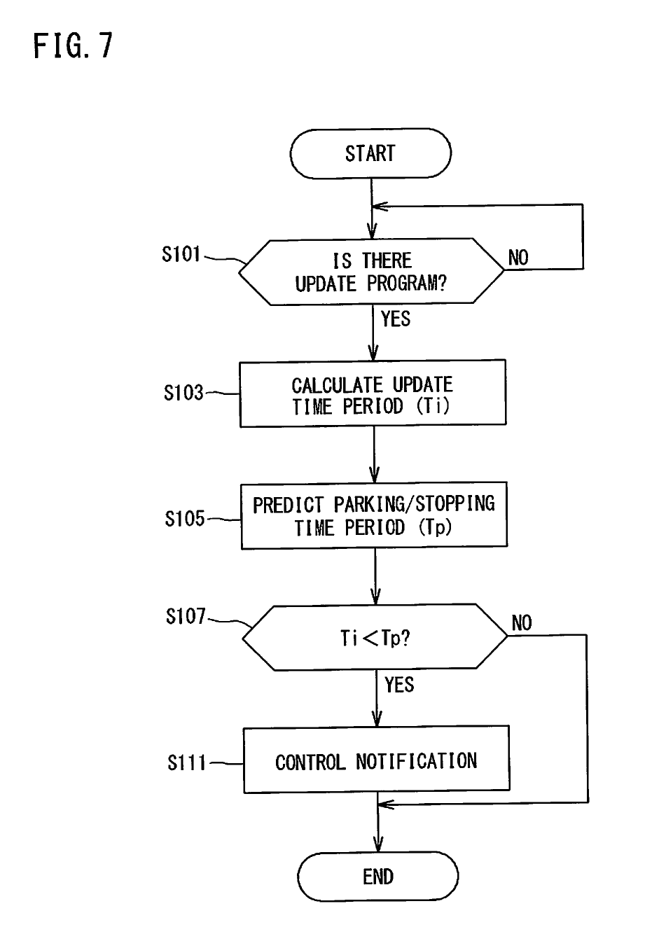

FIG. 7 is a flowchart showing an example of a flow of the notification determination process performed in step S5 described above. The process shown in the flowchart of FIG. 7 is implemented such that the CPU 11 of the gateway 10 reads out a program stored in the storage unit 13 to the RAM 12 and executes the read program, thereby exerting the respective functions shown in FIG. 6.

The notification determination process shown in FIG. 7 is started when the timing to start notification determination has come. As for an example of the notification determination start timing, the notification determination process shown in FIG. 7 is started at the timing when a pre-stop state of the vehicle 1, which is prescribed as a state of the vehicle 1 immediately before parking/stopping, is detected. In this case, the notification determination is performed by using the prediction information acquired at the timing when the pre-stop state of the vehicle 1 is detected. While the control program is being updated, since the ECU 30 maintains the repro mode as described above, the vehicle 1 cannot be driven. Therefore, the vehicle 1 needs to be parked/stopped until completion of the updating. In other words, if updating of the control program is notified before the vehicle 1 will be parked/stopped for about a time period required for updating of the control program, the updating is highly likely to be executed (the user is highly likely to permit the updating). Therefore, the timing of notification is desired to be determined such that notification is performed before the vehicle 1 will be parked/stopped for about the time period required for updating of the control program whereas notification is not performed if the vehicle 1 will not be parked/stopped for a time period as long as the time period required for updating of the control program. Therefore, the notification determination shown in FIG. 7 is performed at the timing when the pre-stop state of the vehicle 1 is detected, whereby updating is notified when the vehicle 1 is highly likely to be parked/stopped.

Examples of the pre-stop state of the vehicle 1 include: timing at which the user shows his/her intention to stop (engine operation or shift operation); timing at which an operation to turn off light in the vehicle 1 is accepted; timing at which doors of the vehicle 1 are unlocked; timing at which a combination of any of the above timings is detected; and the like. These timings may be set in the CPU 11 of the gateway 10 in advance. These timings being set in advance can dispense with complicated user operations such as a setting operation. Alternatively, these timings may be set by a user operation. By allowing the user to set the timings, the user can control the timing of updating, in accordance with his/her driving pattern, preference regarding updating of the control program, and the like.

As an example of the notification determination start timing, the notification determination process shown in FIG. 7 may be started only at the timing defined on the gateway 10 side, regardless of the state of the vehicle 1. For example, the notification determination may be started at the timing when the gateway 10 receives the control program updating request (step S4) from the management server 5 after the gateway 10 has acquired the update program from the DL server 6, as shown in FIG. 5. Alternatively, the notification determination may be started at the timing when the gateway 10 acquires the update program from the DL server 6 and stores the update program in the storage unit 13. Thus, the timing at which the control program of the ECU 30 is likely to be updated, i.e., the appropriate timing, can be detected with high probability, whereby notification of updating can be performed.

Detection that the notification determination start timing has come is made by the CPU 11. In the case where the notification determination start timing is the timing at which the pre-stop state is detected, the gateway 10 acquires information from each of the ECUs 30 connected thereto at any time or at prescribed timings, and detects the pre-stop state by using the information. Examples of the information used for detecting the pre-stop state include: the operation state of the engine; the traveling speed; ON/OFF or set value information of each operation unit; and the like. The CPU 11 may use the information acquired from each ECU 30 for detecting the pre-stop state, as prediction information when the parking/stopping time period Tp is predicated (step S105) in the subsequent notification determination. That is, the CPU 11 may store the information temporarily in the storage unit 13 so as to be used for notification determination. Instead of storing the information, the CPU 11 may acquire the prediction information by, for example, communicating with the corresponding ECU 30 when notification determination is performed.

When the notification determination start timing has come, the CPU 11 starts the process shown in FIG. 7. With reference to FIG. 7, when the notification determination start timing has come, the CPU 11 checks whether or not an unprocessed update program is accumulated in the storage unit 13 (step S101). If the corresponding update program is accumulated in the storage unit 13 (YES in step S101), the CPU 11 calculates or acquires the update time period Ti of the update program (step S103).

Next, the CPU 11 executes a process of predicting the parking/stopping time period Tp (step S105). In the case where the information acquired from the ECU 30 is temporarily stored as described above, the CPU 11 applies the prediction condition C to the information used as the prediction information, thereby predicting the parking/stopping time period Tp. In the case where the information from the ECU 30 is not stored or more information is required, the CPU 11 acquires the necessary prediction information, and applies the prediction condition C to the prediction information, thereby predicting the parking/stopping time period Tp.

The CPU 11 determines whether or not notification is possible, by comparing the update time period Ti of the update program acquired in step S103 with the parking/stopping time period Tp predicated in step S105 (step S107). For example, when the update time period Ti is shorter than the parking/stopping time period Tp (Ti<Tp) (YES in step S107), the CPU 11 determines that notification is possible. Otherwise (NO in step S107), the CPU 11 does not determine that notification is possible. Then, based on the determination result, the CPU 11 controls notification on the display device 70 (step S111). That is, when notification is possible, in step S111, the CPU 11 transfers, to the display device 70, information for displaying a notification screen, and instructs the display device 70 to perform display. When notification is not possible, the CPU 11 does not perform this process.

Preferably, the CPU 11 determines whether or not notification is possible, by using, as a determination condition, the information regarding the state of the on-vehicle device, of the prediction condition C described above.

### Effect of First Embodiment

According to the program updating system of the first embodiment, updating is notified to the user at an appropriate timing among the timings at which the control program of an ECU is updatable. The timing appropriate for notification is the timing at which the user is highly likely to update the control program. When the user is highly unlikely to update the control program, updating is not notified (even if the control program is updatable). If updating is notified at the timing when the user will not update the control program, the user may feel bothered. Since updating is notified at the timing when the user is highly likely to update the control program whereas updating is not notified at the timing when the user is not likely to update the control program, the opportunity that the user feels bothered is reduced.

The timing at which the user is highly likely to update the control program, which is the timing appropriate for notification, is determined based on the update time period Ti of the control program and the parking/stopping time period Tp. For example, when the update time period Ti is shorter than the parking/stopping time period Tp, this is determined as the timing at which the user is highly likely to update the control program, i.e., the timing appropriate for notification. That is, when the time (update time period Ti) during which the user cannot drive the vehicle 1 due to updating of the control program is longer than the parking/stopping time period Tp, it is determined that the control program is less likely to be updated, and notification is not made at this timing. Thus, the possibility that notification of updating is made at the timing when the user is not likely to update the control program is reduced. Thus, the opportunity that the user may feel bothered is reduced.

According to the program updating system of the first embodiment, since the parking/stopping time period Tp is predicated by using the prediction information including at least one of the parking/stopping position and the parking/stopping time, the parking/stopping time period Tp is predicated with high accuracy. Thus, the possibility that notification of updating is made at the timing when the user is not likely to update the control program can be further reduced.

### Second Embodiment

In a program updating system according to a second embodiment, a traveling model of the vehicle 1 is used for prediction of the parking/stopping time period Tp. The traveling model is a model of traveling patterns of the vehicle 1, which is generated based on an accumulated traveling state of the vehicle 1. The traveling model includes, for example, traveling patterns for every day of the week, and hourly traveling patterns.

The CPU 11 of the gateway 10 according to the second embodiment further includes a learning unit 116 shown in FIG. 6, for predicting the parking/stopping time period Tp as described above. Further, the storage unit 13 is provided with a model map storage unit 131 that stores the traveling model generated by the learning unit 116. The learning unit 116 and the model map storage unit 131 are an example of a traveling model acquisition unit that acquires the traveling model.

The learning unit 116 is a model generation unit that generates the traveling model, based on the accumulated traveling state of the vehicle 1 within a predetermined time period. For example, the learning unit 116 collects information indicating the traveling state of the vehicle 1 for the predetermined time period, by communicating with the corresponding ECU 30 through the in-vehicle communication unit 14. Examples of the information indicating the traveling state of the vehicle 1 include: the ON/OFF state of the engine; the operating condition of the engine; and the ON/OFF state of the power supply. The learning unit 116 collects the position of the vehicle, the date and time, and the like, as the information indicating the traveling state, by communicating with a car navigation device, a user's mobile terminal device such as a smart phone, or the like through the wireless communication unit 15. The learning unit 116 statistically processes the information obtained within the predetermined time period to generate traveling patterns of the vehicle 1 for time periods, days of the week, seasons of the year, and the like. The learning unit 116 models the traveling patterns as a traveling model. The method of the statistical process used for generating the traveling patterns is not limited to a specific method, and any method can be adopted.

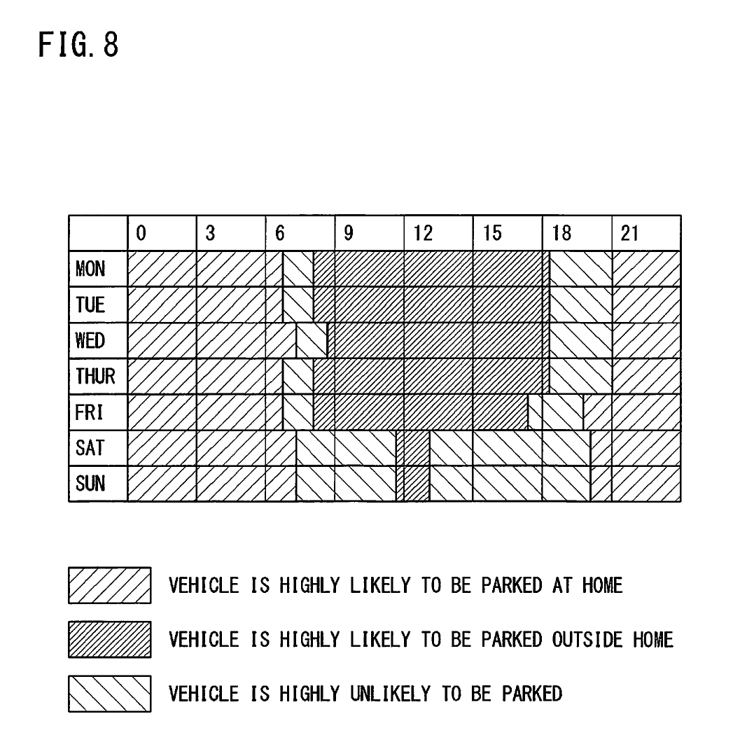

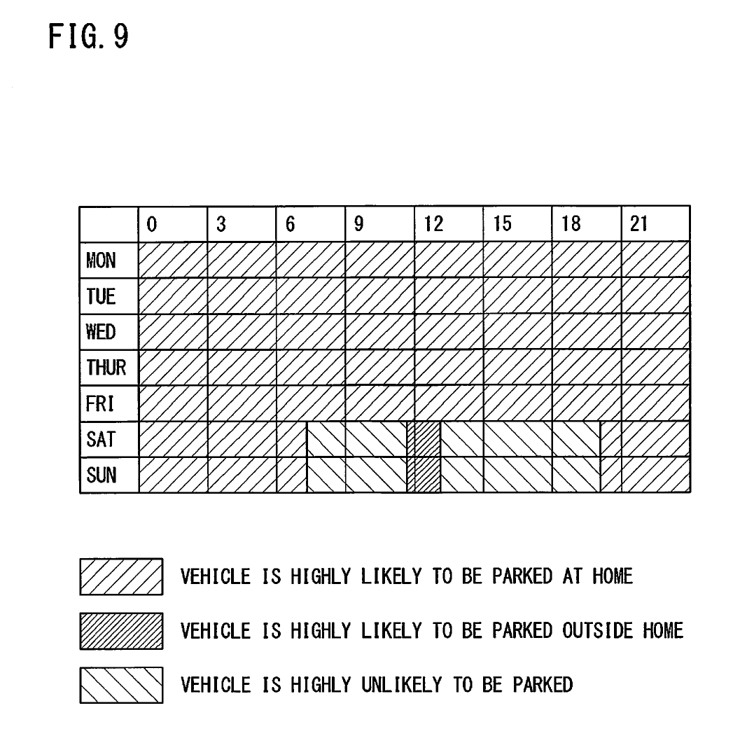

FIG. 8 and FIG. 9 each show a specific example of the traveling model of the vehicle 1. FIG. 8 shows a specific example of the traveling model in the case where the vehicle 1 is used for commuting to work. FIG. 9 shows a specific example of the traveling model in the case where the vehicle 1 is mainly used on holidays (Saturday and Sunday).

In this case, the learning unit 116 acquires, during the predetermined time period, the traveling state (e.g., whether the vehicle 1 is traveling or stopping) and the date and time information, at predetermined timings such as regular intervals. Then, for example, the learning unit 116 accumulates the traveling state for each day of the week and for each time period to learn the tendency of the traveling state, thereby generating traveling patterns and modeling the traveling patterns.

For example, the traveling model is generated as a model map MM which is a map type information as shown in FIG. 8 and FIG. 9. The learning unit 116 stores the generated model map MM in the model map storage unit 131.

When predicting the parking/stopping time period Tp, the prediction unit 112 refers to the traveling model. For example, it is assumed that the model map MM regarding the vehicle 1 represents the traveling model shown in FIG. 8. In this case, assuming that the vehicle 1 is parked at the user's home at a time within a time period at night, the prediction unit 112 predicts that the parking/stopping time period Tp is a time period until 7 o'clock the next morning, based on the traveling model shown in FIG. 8.

The prediction unit 112 may predict the parking/stopping time period Tp by combining the traveling model with the aforementioned prediction condition C. For example, it is assumed that the vehicle 1 whose model map MM represents the traveling model shown in FIG. 8 is parked at a place other than the user's home at a time within a time period from 7 a.m. to 8 a.m. In this case, the prediction unit 112 applies the condition 3 to the parking outside the user's home (point A). Further, with reference to the traveling model shown in FIG. 8, since this parking is made outside the user's home (point A) at the time within the time period in which the vehicle 1 is highly unlikely to be parked, the prediction unit 112 predicts that the parking/stopping time period Tp is a short time (e.g., 10 minutes) that is defined in advance for this condition.

Since the prediction unit 112 predicts the parking/stopping time period Tp by using the traveling model, the prediction accuracy for the parking/stopping time period Tp can be further improved. As a result, the accuracy of notification determination can be further improved.

The determination unit 114 may use the traveling model when determining whether or not notification is possible. For example, when the vehicle 1 is parked at the user's home (point A), the prediction unit 112 predicts that parking/stopping time period Tp=8 (hours), based on the aforementioned condition 1. However, in the case where the model map MM of the vehicle 1 represents the traveling model shown in FIG. 9, when the parking date and time is 14 o'clock on Saturday, the determination unit 114 does not determine that notification is possible, based on the traveling state indicated in the traveling model shown in FIG. 9. The reason is as follows. Since this parking/stopping is made in the time period in which the vehicle 1 is highly unlikely to be parked, according to the traveling model of the vehicle 1, even if the aforementioned parking/stopping time period Tp is predicted, it is determined that the vehicle 1 is highly unlikely to be parked/stopped (or is parked/stopped for a short time).

Thus, the determination unit 114 determines whether or not notification is possible, by using the traveling model, whereby the accuracy of notification determination can be further improved.

The traveling model acquisition unit may acquire a traveling model, which is generated and stored in another device such as the management server 5, from the other device. In this case, the other device such as the management server 5 generates the traveling model by acquiring traveling information form the ECUs 30.

### Third Embodiment

In the program updating system according to any of the first and second embodiments, notification determination is performed in the gateway 10 which is an apparatus for controlling the process regarding control program updating in an ECU 30 whose control program is to be updated. The notification determination may be performed in any apparatus (control apparatus) capable of controlling the process regarding control program updating in the ECU 30. The control apparatus may be, for example, the ECU 30 whose control program is to be updated.

In this case, the respective functions shown in FIG. 6 are implemented by the CPU 31 of the ECU 30 such that the CPU 31 reads out the programs stored in the storage unit 33 to the RAM 32 and executes the read programs. The ECU 30 performs the notification determination upon receiving the update program from the gateway 10, upon receiving an updating request, or when the update program is stored in the storage unit 33. Upon determining that notification is possible, the ECU 30 outputs a control signal that causes the display device 70 to perform notification, to the display device 70 directly or via the gateway 10. Alternatively, the notification control unit 115 may be included in the CPU 11 of the gateway 10, and the ECU 30 may transmit the result of the notification determination to the gateway 10.

### Fourth Embodiment

The control apparatus that performs notification determination may be a control apparatus outside a vehicle. As shown in FIG. 5, the management server 5 requests the gateway 10 to perform updating the control program in the ECU 30 (step S4), and therefore, it can be said that the management server 5 is also a control apparatus that controls the process regarding control program updating in the ECU 30. Accordingly, notification determination may be performed in the management server 5.

When the management server 5 performs notification determination, the respective functions shown in FIG. 6 are executed by the CPU 51 of the management server 5 such that the CPU 51 reads out the programs stored in the ROM 52 to the RAM 53 and executes the read programs. In this case, the information acquisition unit 111 acquires prediction information by communicating with the ECU 30 or other devices. Based on the determination result, the notification control unit 115 may request the gateway 10 to cause the display device 70 to perform notification.

The management server 5 may perform notification determination before requesting the gateway 10 to perform updating of the control program (step S4). When notification is possible, the management server 5 may request the gateway 10 to perform notification as well as updating of the control program. In this case, the management server 5 may not request the gateway 10 to perform updating of the control program when the determination result is that notification is not possible, and may request the gateway 10 to perform updating of the control program when the determination result is that notification is possible. Likewise, the management server 5 may perform notification determination before requesting the gateway 10 to download the update program (step S1). In the case where the management server 5 and the DL server 6 are configured as a single server unit, notification determination may be performed before these servers transmit the update program to the gateway 10 (step S2).

It is noted that the embodiments disclosed herein are merely illustrative in all aspects and should not be recognized as being restrictive. The scope of the present invention is defined not by the above description but by the scope of the claims, and is intended to include meaning equivalent to the scope of the claims and all modifications within the scope.

### REFERENCE SIGNS LIST

1 vehicle

2 wide-area communication network

5 management server (control apparatus)

6 DL server (control apparatus)

10 gateway (control apparatus)

11 CPU

12 RAM

13 storage unit

14 in-vehicle communication unit

15 wireless communication unit

30 ECU (on-vehicle control device)

31 CPU

32 RAM

33 storage unit

34 communication unit

35 start-up unit

51 CPU

52 ROM

53 RAM

54 storage unit

55 communication unit

70 display device

111 information acquisition unit

112 prediction unit

113 calculation unit

114 determination unit

115 notification control unit (updating control unit)

116 learning unit (model generation unit)

131 model map storage unit

Tp parking/stopping time period (first time period)

Ti update time period (second time period)

1. A control apparatus configured to control updating of a control program to be used to control a target device installed in a vehicle by an on-vehicle control device for controlling the target device, the control apparatus comprising:
a prediction unit configured to predict a parking/stopping time period of the vehicle to obtain a first time period as a predicted time period;
an updating control unit configured to control, based on the first time period, a process regarding updating of the control program; and
an information acquisition unit configured to acquire information indicating a state of the vehicle, as information for prediction of the parking/stopping time period, wherein
the prediction unit obtains the first time period by using the information for prediction and a traveling model as a prediction condition stored in advance, the traveling model being obtained based on an accumulated traveling state of the vehicle.

2. (canceled)

3. The control apparatus according to claim 1, wherein the information for prediction includes at least one of a parking/stopping position and a parking/stopping time of the vehicle.

4. The control apparatus according to claim 1, wherein the information acquisition unit acquires, as the information for prediction, the information indicating the state of the vehicle, at a timing when a pre-stop state, which is prescribed as a state of the vehicle immediately before parking/stopping, is detected.

5. (canceled)

6. The control apparatus according to claim 1 further comprising a model generation unit configured to generate the traveling model, based on the accumulated traveling state of the vehicle.

7. The control apparatus according to claim 1, wherein the updating control unit controls the process regarding updating of the control program, based on a result of comparison between the first time period and a second time period that is a time period required for the process regarding updating of the control program.

8. The control apparatus according to claim 7, further comprising:
an update time period acquisition unit configured to acquire the second time period; and
a determination unit configured to determine whether or not execution of the process regarding updating of the control program is possible, by comparing the first time period with the second time period.

9. The control apparatus according to claim 8, wherein the determination unit determines whether or not execution of the process regarding updating of the control program is possible, also based on a state of a device installed in the vehicle.

10. The control apparatus according to claim 1, wherein the updating control unit performs notification of updating of the control program, as the process regarding updating of the control program.

11. A method for updating a control program to be used to control a target device installed in a vehicle by an on-vehicle control device for controlling the target device, the method comprising the steps of:
predicting a parking/stopping time period of the vehicle to obtain a first time period as a predicted time period;
controlling, based on the first time period, a process regarding updating of the control program; and
acquiring information indicating a state of the vehicle, as information for prediction of the parking/stopping time period, wherein
the predicting step comprises obtaining the first time period by using the information for prediction and a traveling model as a prediction condition stored in advance, the traveling model being obtained based on an accumulated traveling state of the vehicle.

12. A non-transitory computer-readable storage medium with a computer program to control updating of a control program to be used to control a target device installed in a vehicle by an on-vehicle control device for controlling the target device, the computer program causing a computer to execute the steps of:
predicting a parking/stopping time period of the vehicle to obtain a first time period as a predicted time period;
controlling, based on the first time period, a process regarding updating of the control program; and
acquiring information indicating a state of the vehicle, as information for prediction of the parking/stopping time period, wherein
the predicting step comprises obtaining the first time period by using the information for prediction and a traveling model as a prediction condition stored in advance, the traveling model being obtained based on an accumulated traveling state of the vehicle.
